(19) United States
(12) Patent Application Publication
(10) Pub. No.: US 2008/0260120 A1
(43) Pub. Date: Oct. 23, 2008

(54) Evaluating The Use Of Services Accessible From A Terminal

(75) Inventors: David Minodier, Lannion (FR); Gilles Ivanoff, Trebeurden (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 12/097,809

(22) PCT Filed: Dec. 19, 2006
(86) PCT No.: PCT/FR2006/051387

§ 371 Date: Jun. 17, 2008

(30) Foreign Application Priority Data
Dec. 19, 2005 (FR) 0553933

(51) Int. Cl. H04M 11/00

(52) U.S. Cl. 379/93.02

(57) ABSTRACT

To evaluate the use of services accessible from a user terminal via a telecommunication network, an authentication sever authenticates the user of the terminal and transmits identifiers of the services to a control device to authorize the user terminal to access the services. In response to the service identifiers triggering an opening of control sessions for accessible services from the user terminal, an evaluation module evaluates the data traffics exchanged between the user terminal and service servers dispensing the services accessible in traffic accounts, and transmits to a management server, service control messages each including a service identifier and a traffic account relating to an accessible service after the closure of control sessions relating to the services.

### BACKGROUND OF THE INVENTION

1—Related Applications

The present invention relates to an evaluation of the use of services accessible from a user terminal in a telecommunication network. More particularly, it deals with a management of the services to which the user terminal is allowed access.

2—Field of the Invention

Currently, authentication protocols incorporate authentication functions in order to authorize access to services. According to the 802.1x standard protocol, when a user terminal is authenticated to access a single service, an authentication device sends a control message or a “start metering” ticket to a server responsible for metering operations for billing for the service. Similarly, when the user terminal is no longer authenticated, the authentication device sends an “end metering” ticket to said server. The information contained in the “start metering” and “end metering” tickets comprises metering information such as service usage dates and volumes of data received and transmitted by the user terminal during the period of use of the service.

However, there is no protocol that specifies a mechanism for sending these tickets when the user terminal is authorized to access several services after a single authentication.

### OBJECT OF THE INVENTION

An object of the invention is to track the use of services supplied to a user terminal, when an authentication server authorizes the user terminal to access the services after a single authentication of the user terminal, in order to improve the billing for these services.

### SUMMARY OF THE INVENTION

A method according to the invention for evaluating the use of services accessible from a user terminal via a telecommunication network, including a step for authenticating the user terminal with an authentication server and a step for transmitting several identifiers of services to a control device to authorize the user terminal to access the services, is characterized in that

the reception of the service identifiers triggers an opening of a control session for each service accessible from the user terminal in order to evaluate the data traffics exchanged between the user terminal and service servers dispensing the services accessible via the control device in traffic accounts, and

in that it includes a step for transmitting to a management server, service control messages each including a service identifier and a traffic account relating to an accessible service after the closure of control sessions relating to the services.

After a single authentication, the user has access to the services to which he subscribes without being obliged to use them. The control messages make it possible to know which services are requested by the user and the quantity of resources required. The control messages give information on the services used and are centralized in the management server, so facilitating the billing for the services used. Network administrators can use the information relating to the control messages to trace the activity of a user for a security audit or for statistical purposes.

For each service used, control messages are generated, which makes management of the service operating costs more effective and billing for the use of the services by the user more accurate. Moreover, this more accurate billing is useful to the user to better adapt the services to his requirements, without, for example, relying on rate plans which do not reflect the actual use of the services.

According to another characteristic of the invention, the method can also include, in the control device, a periodic transmission of an intermediate control message including the service identifier and the traffic account for each service control session.

In the case of a lengthy xDSL (Digital Subscriber Line) type connection between the user terminal and the control device, the intermediate messages are needed for the billing for one or more services according to a usage time that is shorter than the connection time.

The invention also relates to a device for evaluating the use of services accessible from a user terminal via a telecommunication network, an authentication server authenticating the user of the terminal and transmitting identifiers of services to said control device to authorize the user terminal to access the services. The device is characterized in that it includes:

means able to trigger, on receipt of the service identifiers, an opening of a control session for each service accessible from the user terminal, in order to evaluate the data traffics exchanged between the user terminal and service servers dispensing the services accessible via the control device in traffic accounts, and

means of transmitting to a management server service control messages each including a service identifier and a traffic account relating to a service accessible after the closure of control sessions relating to the services.

Finally, the invention relates to a computer program including program instructions for implementing a method according to the invention when said instructions are executed by a processor.

### BRIEF DESCRIPTION OF THE DRAWINGS

Other characteristics and advantages of the present invention will become more clearly apparent on reading the following description of several preferred embodiments of the invention, given as nonlimiting examples, with reference to the corresponding appended drawings in which:

FIG. 1 is a schematic block diagram of a telecommunication system for evaluating the use of services accessible from a user terminal according to the invention; and

FIG. 2 is an algorithm of a method of evaluating the use of services accessible from a user terminal according to the invention.

### DESCRIPTION OF THE EMBODIMENTS

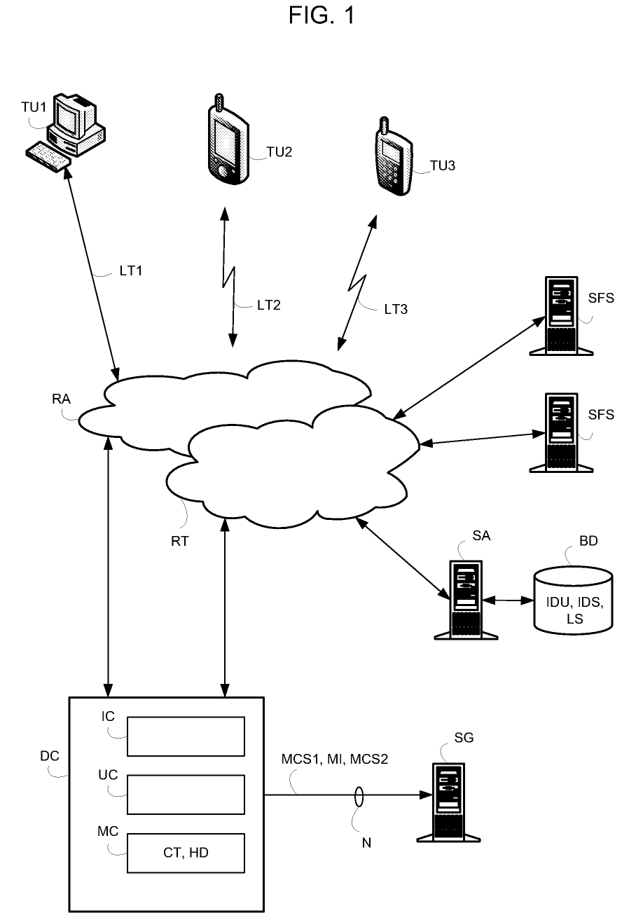

Referring to FIG. 1, the telecommunication system includes at least one user terminal such as a user terminal TU1, TU2 or TU3, an authentication server SA, a database BD connected to the authentication server SA, a control device DC, a management server SG and at least one service provider server SFS.

The control device DC communicates with the authentication server SA by an Internet-type telecommunication network RT. The control device communicates with the management server SG via a local area network or via dedicated lines. In a variant, the control device communicates with the management server via a local area network or via dedicated lines through the network RT. In another variant, the authentication server SA and the management server SG are combined into or incorporated in a single server, which is connected to or includes the database BD.

The user terminals TU1, TU2 and TU3 communicate with the control device DC via respective access networks RA. According to the embodiment illustrated in FIG. 1, the terminals are linked to respective access networks RA by respective links LT1, LT2 and LT3.

A user terminal TU1 is, for example, a personal computer directly linked by modem to the link LT1 of xDSL (Digital Subscriber Line) type or ISDN (Integrated Services Digital Network) type, linked to the corresponding access network RA. The link LT1 can also be a wired link of the serial cable type, or an Ethernet type connection lead, or USB (Universal Serial Bus) or even optical fiber.

According to another example, a user terminal TU2 comprises an electronic telecommunication device or object that is personal to the user and that can be a communicating personal digital assistant PDA, or a smartphone, possibly linked by radio link LT2 to an access terminal of a wireless public network with short range of the WLAN (Wireless LAN) type, or compliant with one of the 802.1x standards, or of medium range according to the WIMAX (World wide Interoperability Microwave Access) protocol.

According to yet another example, a user terminal TU3 is a mobile cellular radiocommunication terminal, the link LT3 is a radiocommunication channel, and the respective access network RA includes the fixed network of a radiocommunication network, for example of UMTS (Universal Mobile Telecommunications System) type.

More generally, the terminal TU1, TU2, TU3 can be any other communicating domestic terminal, portable or otherwise, such as a video games console, or an intelligent television receiver cooperating with a remote control with display, or an alphanumeric keyboard also serving as a mouse via an infrared link.

According to another example, the access network RA includes a network connecting several user terminals.

The user terminals TU1, TU2 and TU3 and the access networks RA are not limited to the above examples and can comprise other known terminals and access networks. The user terminals are designated TU without differentiation hereinafter in the description.

The control device DC in particular includes a communication interface IC, a central processing unit CPU and an evaluation module ME including traffic counters in sufficient numbers to be respectively assigned to the users and to the services for each user.

When the user terminal TU is linked to the network RA by an xDSL type link, the control device DC is a digital subscriber line access multiplexer DSLAM. By way of nonlimiting examples, the control device can be an Ethernet switch, an IP (Internet Protocol) router or a wireless access terminal, suited to the access network RA related to the user terminal.

The communication interface IC includes a physical port dedicated to the point-to-point communications via the respective access network RA between the control device DC and the user terminal TU connected to this port. Moreover, the communication interface IC provides a gateway function between the access network RA and the telecommunication network RT by the transport of data exchanged between the user terminal and one or more service provider servers SFS. According to the 802.1x standard, the physical port is split into two logical ports, connected in parallel to the physical port. The first logical port, called as a “controlled port”, is in a “blocked” or “unblocked” state. In the unblocked state, the first logical port authorizes a communication between a user terminal TU and one or more service provider servers SFS. The first logical port is in the blocked state as long as the user terminal TU is not authenticated and therefore is not authorized to access at least one service offered by the service provider SFS. The second logical port, which is said to be “uncontrolled”, remains always accessible, and manages only frames specific to the 802.1x protocol for the authentication of a user terminal TU by the authentication server SA.

Once the authentication server SA authenticates the user terminal TU, the first logical port is unblocked and the user terminal can communicate with one or more service provider servers SFS.

The communication between the user terminal TU and the control device DC is based on the EAP protocol (Extensible Authentication Protocol). EAP packets are encapsulated and transported in specific EAPOL (EAP Over Lan) Ethernet frames. The communication technique at the link layer level therefore relies on Ethernet packets.

The authentication server SA and the control device DC communicate by EAP packets in a format specific to the authentication server SA, without modification of the content of the EAP packets by the control device which also reads information included in the EAPOL packets in order to block or unblock the controlled port. More specifically, the arrangement of the different layers for the exchange of packets between the control device DC and the authentication server SA relies on the RADIUS (Remote Authentication Dial-In User Service) protocol, the transport layer of which is based either on the UDP transport protocol (User Datagram Protocol), or on the TCP transport protocol (Transport Control Protocol) to transmit IP packets.

Before the user terminal TU is connected to the physical port of the communication interface IC of the control device, the controlled port of the latter is blocked, and only the uncontrolled port is accessible. On connection, the user terminal receives an EAP packet originating from the authentication server SA prompting it to authenticate itself. The user terminal transmits a response to the uncontrolled port which forwards the response to the authentication server SA. A communication is then set up between the user terminal and the authentication server via the relay provided by the uncontrolled port of the communication interface of the control device in order to authenticate the user terminal.

Depending on the authentication technique used, the user terminal TU must transmit to the authentication server SA, for example, an identifier and a password, or a set of keys or certificates.

The evaluation module ME generates service control messages including data concerning the use of a service in relation to a user terminal. Said data is, for example, service usage dates, data volumes exchanged between the user terminal and a service provider server, a service identifier IDS and a user identifier IDU. The control messages are necessary to the operator managing the management server SG for billing for the services offered.

A first service control message MCS1 is generated for each service accessible by a user, that is, a service for which a subscription has been taken out by the user, when a communication between the terminal TU of the user and a service provider server SFS dispensing the service is set up.

A second service control message MCS2 is generated for each service accessible by the user when a communication between the terminal TU of the user and the server SFS dispensing the service is terminated, for example when the user terminal TU disconnects from the control device DC.

Moreover, an intermediate control message MI can be generated at regular intervals following periodic reauthentications of the user terminal during the communication between the latter and a service provider server SFS.

Thus, when the user of the terminal TU accesses N services, with N≧1, N first service control messages MCS1 and N second service control messages MCS2 are generated and K×N intermediate control messages MI are generated, with K≧1.

The authentication server SA authenticates the user terminals and authorizes them to access services. The authentication server is, for example, a server compliant with the RADIUS protocol. According to other examples, the authentication server SA is compliant with the “Diameter” or TACACS (Terminal Access Controller Access Control System) protocol.

The database BD is linked to the authentication server SA, that is, it is either incorporated in the authentication server SA, or incorporated in a database management server and linked to the authentication server by a local or remote link. The database BD in particular includes information necessary for authentication and authorization for user terminals such as user identifiers IDU, service identifiers IDS and lists LS of authorized services to which the users subscribe.

The user identifier IDU is independent of the terminal TU used by the user and identifies the user of the terminal during a communication session between the terminal and a service provider server for example. To assign a user identifier IDU, the user must first subscribe to or register with the authentication server SA, in order to obtain an identifier and a password associated with the user identifier. For example, the identifier and the password are input on the keyboard of the user terminal or spoken to the terminal by the user.

The service provider servers SFS are respectively managed by service providers offering services such as Internet access, videoconferencing or telephony over IP, and entering into mutual recognition agreements with a management server SG in order to use the data stored in the management server SG for the billing for the services offered. To avoid overloading FIG. 1, only two service provider servers are represented, designated without differentiation by SFS. Each server SFS is linked to the control device DC via the network RT.

The invention applies to various objects, whether services proper or products obtained indirectly by services. A preferred embodiment of the method of evaluating the use of services according to the invention is described below for evaluating the use of services accessible from a user terminal TU via a telecommunication network RT. It will be understood that the inventive method is also applicable for evaluating the use of services accessible from user terminals TU via a telecommunication network RT.

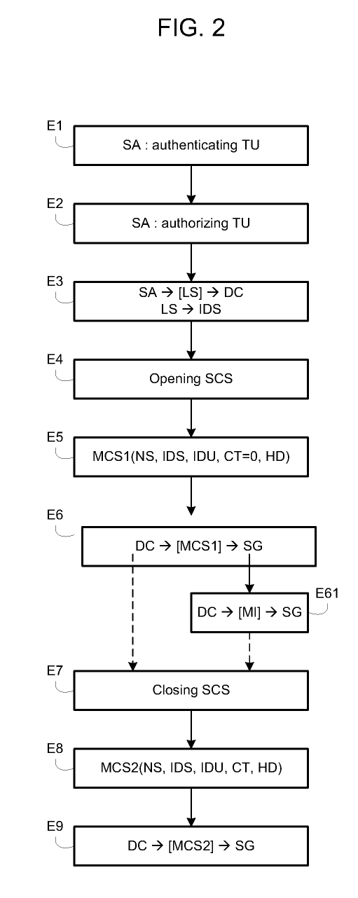

Referring to FIG. 2, the method of evaluating the use of services accessible from a user terminal according to the preferred embodiment of the invention includes known steps E1 and E2, respectively for authentication and authorization, and steps E3 to E9 executed automatically in the control device DC.

Initially, the user of a terminal TU, who has taken out a subscription to several services, wants to access at least one of these services.

In the step E1, the user terminal TU connects to the communication interface IC of the control device DC in order to communicate with the authentication server SA, as described previously. The authentication server SA authenticates the user of the terminal TU in a known way, for example by analyzing an identifier and a password that are associated transmitted by the user terminal.

In the step E2, after the user has been authenticated, the authentication server SA accesses the database BD to consult a list of services LS correlated to the identifier IDU of the user of the terminal TU associated with the identifier and the password of the authenticated user in order to authorize access to the services to which the user subscribes. The authentication server SA creates an authorization response including in particular the list of authorized services LS, service identifiers IDS and attributes relating to the access to the authorized services.

In the step E3, the authentication server SA transmits the authorization response including the list of services LS to the control device DC which identifies the services included in the list LS. For example, the central processing unit UC of the control device DC reads the received service identifiers IDS respectively determining addresses of service provider servers SFS in order to unblock the first logical port of the communication interface IC and order an interconnection of the user terminal TU and each of the addressed service provider servers, via the control device. This interconnection in the communication interface IC involves setting up a communication between the control device and each of the addressed service provider servers and joining the communication between the user terminal and the control device to the communication between the control device and each of the addressed service provider servers.

In the step E4, the evaluation module ME opens service control sessions SCS respectively for the identified services. The control session of a service is identified by a session number NS set in particular according to the service identifier IDS and the user identifier IDU and corresponds to the communication session relating to the service between the user terminal TU and a service provider server SFS.

In the step E5, the evaluation module ME generates a first service control message MCS1 for each identified service and, consequently, for each service control session SCS. The first control message MCS1 comprises the session number NS, the service identifier IDS and the user identifier IDU.

As a variant, the first control message MCS1 further includes an address of the control device DC which can be similar to an IP address or an MAC (Medium Access Control) address and the account CT of a traffic meter which evaluates the data traffic exchanged between the user terminal TU and the service provider server SFS via the control device DC. The traffic account CT, included in the first service control message MCS1, corresponds, for example, to values given at the meter output such as the number of bytes transmitted to and/or originating from the user terminal TU for a service. In this example for a first service control message MCS1, the traffic account is set to zero.

In another variant, for the control session SCS of each service, the evaluation module ME simultaneously activates a time clock with the traffic meter relating to the service and the first control message MCS1 relating to the service includes timestamping data HD (date, hour and minutes) supplied by the time clock. The timestamping data is used to estimate the service usage time and will be stored with the traffic accounts in the management server SG.

In the step E6, the evaluation module ME transmits to the management server SG the first service control messages MCS1 generated relating to the opening of the respective service control sessions SCS.

As a variant, each time a predetermined cyclic period expires, the evaluation module ME generates an intermediate control message MI for each open service control session SCS after a reauthentication of the user terminal TU and transmits it to the management server SG in a step E61. The content of the intermediate control message MI is similar to that of the first service control message MCS1, including in particular the same session number NS. However, the traffic account CT has a non-zero value.

In a respective step E7 for each identified service, the evaluation module ME closes the service control session SCS for the identified service, for example when the communication between the user terminal and the service provider server SFS is terminated.

As a variant, the evaluation module ME simultaneously closes all the service control sessions SCS for the respective identified services, for example when the user terminal TU disconnects from the control device DC.

In a respective step E8 for each identified service, the evaluation module ME generates a second service control message MCS2 for the closed control session SCS of the identified service. The content of the second control message MCS2 is similar to that of the first service control message MCS1, and includes in particular the same session number NS which identifies the service control session SCS, and the traffic account CT evaluated by the meter assigned to the service and the timestamping data HD.

In the step E9, after the last closure of the control session of one of the identified services for the user of the terminal TU, the evaluation module ME transmits to the management server SG the second service control messages MCS2 generated relating respectively to the closed service control sessions SCS.

In the management server SG, the traffic account CT extracted from a received message MCS2 indicates the volume of data received and/or transmitted by the user terminal TU during the service usage time. Also in the management server SG, the timestamping data HD on closure of the session extracted from the received message MCS2 is compared to the timestamping data HD extracted from a prior message MCS1 and stored on opening of the session to deduce therefrom the actual usage time of the service in relation to the service control session SCS by the user of the terminal TU.

At the end of the step E9, the management server SG stores all the control messages MCS1, MI and MCS2 in a database. In response to each received control message including the identifier IDS of a respective service, the management server SG cumulates the received traffic account with a total traffic account for the service cumulated since the last bill, and cumulates the usage time of the service with a total usage time of the service cumulated since the last bill in order to archive them and create a next service bill for the user of the terminal TU. Consequently, the management server SG stores in particular the traffic account CT and the timestamping data HD in relation to each of the received control messages.

The invention described here relates to a data processing method and device for evaluating the use of services accessible from a user terminal via a telecommunication network, an authentication server authenticating the user of the terminal and transmitting service identifiers to the control device to authorize the user terminal to access the services. In a preferred embodiment, the steps of the method of the invention are determined by the instructions of a computer program incorporated in the system. The program includes program instructions which, when said program is executed in the system, the operation whereof is then controlled by the execution of the program, execute the steps of the method according to the invention.

Consequently, the invention also applies to a computer program, in particular a computer program stored on or in a storage medium adapted to implement the invention. This program can use any programming language and take the form of source code, object code or an intermediate code between source code and object code, such as a partially compiled form, or any other form desirable for implementing the method according to the invention.

The storage medium can be any entity or device capable of storing the program. For example, the medium can include storage means in which the computer program according to the invention is stored, such as a ROM, for example a CD ROM or a microelectronic circuit ROM, a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

1. A method of evaluating use of services accessible from a user terminal via a telecommunication network, said method including:
authenticating said user of said terminal with an authentication server,
transmitting a plurality of identifiers of services to a control device to authorize said user terminal to access said services,
in response to reception of said service identifiers, triggering an opening of a control session for each service accessible from said user terminal in order to evaluate data traffics exchanged between said user terminal and service servers dispensing said services accessible via said control device to produce traffic accounts, and
transmitting to a management server, service control messages each including a service identifier and a traffic account relating to an accessible service after having closed control sessions relating to said services.

2. A method claimed in claim 1, further including in said control device, after the opening of control sessions of said services, setting to zero the traffic accounts, and transmitting other service control messages each including a service identifier to said management server.

3. A method claimed in claim 1, including cumulating the received traffic account with a total traffic account in said management server responsive to each received service control message including said identifier of a respective service.

4. A method as claimed in claim 1, wherein said control messages further include timestamping data.

5. A method as claimed in claim, further including, in the control device, a periodic transmission of an intermediate control message including the service identifier and the traffic account for each service control session.

6. A method as claimed in claim 1, wherein said authentication server and said management server are combined.

7. A device for evaluating the use of services accessible from a user terminal via a telecommunication network, said device including:
means able to trigger, on receipt of said service identifiers, an opening of a control session for each service accessible from said user terminal, in order to evaluate data traffics exchanged between said user terminal and service servers dispensing said services accessible via said device in traffic accounts, and
means of transmitting to a management server service control messages each including a service identifier and a traffic account relating to a service accessible after having closed control sessions relating to the services.

8. A data processor arrangement for evaluating the use of services accessible from a user terminal via a telecommunication network, said data processor arrangement including being arranged to perform the following operation:
upon reception of said service identifiers, triggering an opening of a control session for each service accessible from said user terminal,
respond to the triggering to evaluate data traffics exchanged between said user terminal and service servers dispensing said services accessible via said control device to produce traffic accounts, and
transmitting to a management server service control messages each including a service identifier and a traffic account relating to an accessible service after having closed control sessions relating to said services.

9. A computer-readable storage medium or a computer-readable storage device storing a computer readable indicia, which when read by a data processor arrangement, causes the data processor arrangement to perform the steps of claim 8.

10. A digital multiplexer of user liens in a telecommunication network, including:
a trigger for triggering, on receipt of said service identifiers, opening of a control session for each service accessible from said user terminal, in order to evaluate data traffics exchanged between said user terminal and service servers dispensing said services accessible via said device in traffic accounts, and a transmitter for transmitting to a management server service control messages each including a service identifier and a traffic account relating to a service accessible after having closed control sessions relating to the services.
